(19) United States
(12) Patent Application Publication
(10) Pub. No.: US 2017/0177554 A1
(43) Pub. Date: Jun. 22, 2017

(54) CULTURALLY RELEVANT EMOJI CHARACTER REPLACEMENT

(71) Applicant: International Business Machines Corporation, Armonk, NY (US)

(72) Inventors: John C. Emmons, Leander, TX (US); Denise Genty, Austin, TX (US); Su Liu, Austin, TX (US); Shunguo Yan, Austin, TX (US)

(21) Appl. No.: 14/974,936

(22) Filed: Dec. 18, 2015

(51) Int. Cl. G06F 17/24; H04L 12/58

(52) U.S. Cl. CPC G06F 17/24; H04L 51/04

(57) ABSTRACT

A computing device determines that an electronic message entered by a sender user for a recipient user includes an emoji character. The computing device determines a replacement emoji character that is more culturally relevant to the recipient user than the emoji character entered by the sender user is. The computing device replaces the emoji character entered by the sender user with the replacement emoji character that has been determined, within the electronic message. The computing device may be the computing device of the sender user, or the computing device of the recipient user.

### BACKGROUND

Particularly with the advent of mobile computing devices like smartphones, emoji characters have become a popular way by which users enhance email messages and text messages. An emoji is literally a picture character or pictograph, and is a single character with a unique code point value as part of a text string that can provide additional meaning to text or provide contextual information to the text to assist in interpretation of the text, among other purposes. To enter an emoji character, on smartphones, for example, a user may switch from an alphabetic keyboard to an emoji keyboard and select the desired emoji.

### SUMMARY

An example method includes determining, by a computing device, that an electronic message entered by a sender user for a recipient user includes an emoji character. The method includes determining, by the computing device, a replacement emoji character that is more culturally relevant to the recipient user than the emoji character entered by the sender user is. The method includes replacing, by the computing device, the emoji character entered by the sender user with the replacement emoji character that has been determined, within the electronic message.

An example computer program product includes a computer readable storage medium having stored thereon program instructions. The instructions are executable by a computing device to cause the computing device to determine that an electronic message entered by a sender user for a recipient user includes an emoji character. The instructions are executable by the computing device to determine a replacement emoji character that is more culturally relevant to the recipient user than the emoji character entered by the sender user is. The instructions are executable by the computing device to replace the emoji character entered by the sender user with the replacement emoji character that has been determined, within the electronic message.

An example computing device includes a processor, a memory, and program instructions stored in the memory and executable by the processor. The instructions are executable by the processor to determine that an electronic message entered by a sender user for a recipient user includes an emoji character. The instructions are executable by the processor to determine a replacement emoji character that is more culturally relevant to the recipient user than the emoji character entered by the sender user is. The instructions are executable by the processor to replace the emoji character entered by the sender user with the replacement emoji character that has been determined, within the electronic message.

### BRIEF DESCRIPTION OF THE DRAWINGS

FIG. 1 is a flowchart of an example method to replace within a message entered by a sender for a recipient an emoji character with a replacement emoji character that is more culturally relevant to a recipient.

FIG. 2 is a flowchart of another example method to replace within a message entered by a sender for a recipient an emoji character with a replacement emoji character that is more culturally relevant to a recipient.

FIG. 3 is a diagram of an example computing device.

### DETAILED DESCRIPTION

As noted in the background section, emoji characters are single picture characters that have become popular to add to email messages and text messages. Examples of text messages include those transmitted over the short message service (SMS) that is ubiquitous among mobile phone operators, as well as those transmitted over proprietary message services that require a particular type of smartphone or installation of a particular type of computer program or “app.” A difficulty with using emoji characters, however, results from the increasing interconnectedness of people across the globe.

Specifically, it is not uncommon for the sender and the recipient of a message to be located in different countries, and thus to be of different cultures. The meaning that the sender may have in mind for an emoji character may therefore be totally different from the meaning that the recipient has in mind for the same emoji character. As such, the potential for creating confusion by using emoji characters is very much real. This problem is exacerbated by the fact that many people may not even have an inkling that what they believe an emoji character means may be very different from what people of other cultures believe the emoji character means.

As some examples, in some cultures an emoji character of a person wearing a surgical mask on his or her face means that the person is sick, whereas in other cultures this same emoji character may mean a doctor, such as a surgeon. In some cultures, an emoji character of a shooting star may indicate dizziness, which is a meaning that other cultures may not share. An emoji character of the two hands with their palms against one another in some cultures expresses apology or gratitude, whereas in other cultures this emoji character connotates praying. In some cultures, an emoji character of a person's face with a teardrop indicates sleeping, whereas in other cultures it indicates sadness or crying.

As further examples, an emoji character of two hands at angles to one another and with their palms outward in some cultures can signify openness or hugging, whereas in other cultures it can suggest the directive to “stop it.” An emoji character that means good luck in some cultures may have a decidedly different meaning in other cultures. An emoji character of a young person with his or her hands placed on the top of the person's head may mean okay in some cultures, whereas in other cultures it may express shock or embarrassment. An emoji character of a person with one the arm extended upwards so that the hand is by the person's hair with palm pointed upwards can mean an informational desk person in some cultures, which is a meaning that other cultures may not ascribe to this emoji character.

Techniques disclosed herein ameliorate the real potential for cross-cultural confusion resulting in the use of emoji characters. An emoji character entered by the sender of an electronic message is replaced with a replacement emoji character that is more culturally relevant to the recipient of the message. The sender may enter an emoji character that in the sender's culture conveys a particular meaning, but the recipient sees a replacement emoji character that conveys the same meaning in his or her culture. As such, cross-cultural confusion between the sender and the recipient is reduced if not eliminated. For example, the sender may select an emoji character of a person wearing a surgical mask on his or her face to indicate that the sender is sick, but the recipient may see a replacement emoji character of a person having a thermometer sticking out of his or her mouth, which in the culture of the recipient connotates being sick.

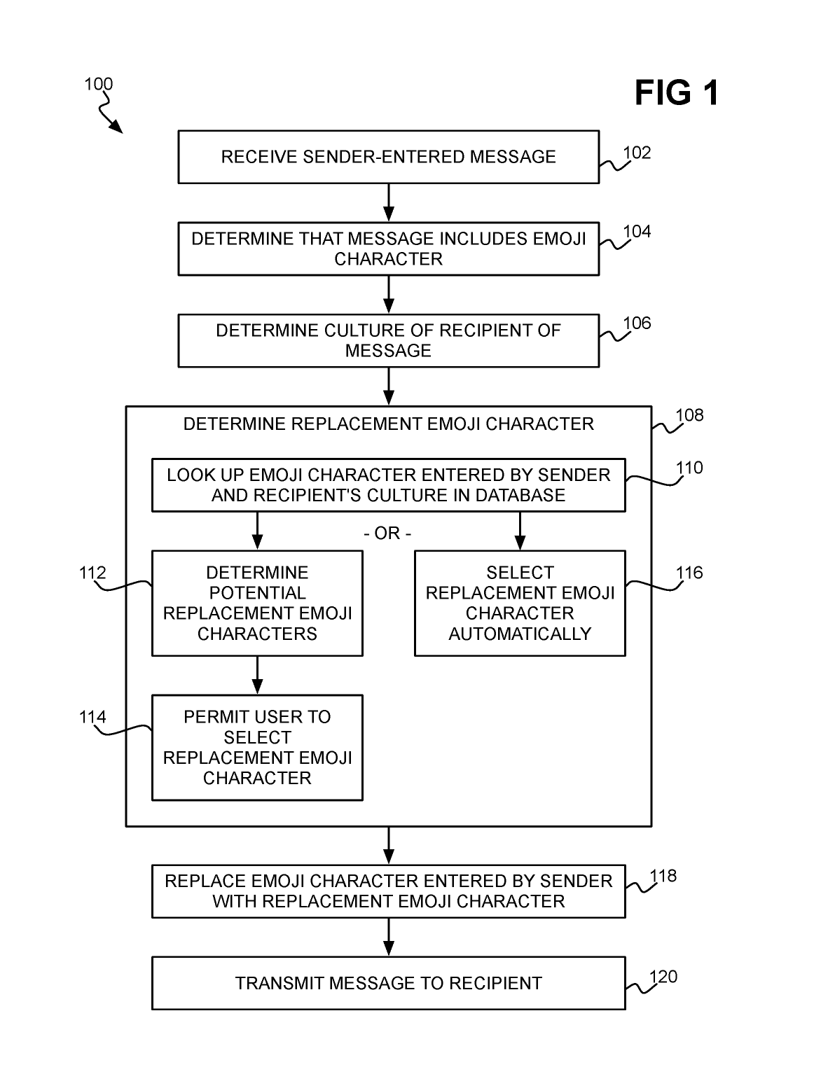

FIG. 1 shows an example method 100 for replacing an emoji character entered by a sender of an electronic message with a replacement emoji character culturally relevant to a recipient of the message. The method 100 is performed at the computing device of the sender, which the sender uses to compose the message and then transmit it to a computing device of the recipient. The electronic message may be an email message, a text message, such as an SMS message, or another type of electronic message. The computing device may be a smartphone or other type of mobile computing device, a tablet computing device, a desktop or laptop computer, or another type of computing device.

The computing device receives the electronic message that the sender has entered or input (102), and determines that the message includes an emoji character (104). Although the method 100 is described in relation to the message including one emoji character, the message can include more than one emoji character, with the process that is described below being performed for each such character. Determining that the message includes an emoji character can be achieved by examining each character of the message on a character-by-character basis. Emoji characters have predefined codes, such as predefined Unicode codes. Therefore, determining that a character is an emoji character is performed by determining that the Unicode code of the character, for instance, is one that corresponds to an emoji character.

The culture of the recipient of the electronic message is determined (106). This determination can be performed in a number of different ways. For instance, the electronic message is said to be intended for a recipient in that it can be addressed to a unique identification, or identifier, of the recipient. This identification may be an email address, or a phone number to which a text message is to be sent, for instance. In at least some cases the identification may therefore provide clues as to the recipient's geographic location, from which the recipient's culture can be ascertained. For example, email addresses may include a two-letter country code suffix from which the country of the recipient can be determined. As another example, phone numbers can include area codes and/or country codes that can be corresponded to cultures.

The culture of the recipient can be determined more generally from the geographic location of the recipient in this respect as well. For example, the sender may have previously stored the mailing or residential address of the recipient, including the recipient's country, state or province, and postal code. Any of this information can be corresponded to the recipient's culture.

The granularity with which the culture of the recipient is determined can vary across implementations. For example, the global peoples of the world may be segmented into a relatively small or a relatively large number of cultures, by geographic location or in another manner. Because replacement emoji characters that are culturally relevant are determined, the number of different emoji characters that represent the same meaning, for instance, may dictate the number of different cultures in this respect.

The culture of the recipient can be determined based on a cultural indication of the recipient that the sender has received from the recipient. For example, if there is a predefined categorization of emoji characters into various cultures, the recipient may specify the culture for which he or she wishes to see the corresponding emoji characters of when viewing messages. This specification may be provided each time the recipient sends an electronic message to the sender, such as in a header field of an email message, or in a predetermined undisplayed field of a text message. Presuming that the sender and the receiver have previously exchanged messages, then, the sender will have previously received this information. The cultural indication can be sent from the recipient in another way as way. As one example, electronic business (or personal) cards are often exchanged in accordance with a predefined format, such as the vCard format, and the cultural indication can be a field within such an electronic business (or personal) card.

The culture of the recipient can also be determined by the sender specifying the cultural indication of the recipient. For instance, the sender may be able to specify the culture of the recipient within the messaging program that the sender uses to compose and transmit electronic messages. As such, if the sender is relatively well acquainted with the recipient or otherwise knows the recipient's culture, the sender can specify this information.

The computing device of the sender determines a replacement emoji character that is culturally relevant to the recipient (108), which is a different emoji character than the one that the recipient entered. Note that the description of the method 100 presumes that the sender-entered emoji character will be replaced by a different, replacement emoji character that is culturally relevant to the recipient. However, some emoji characters may be culturally universal, in which case no such replacement occurs. For example, if no replacement emoji character exists for a particular emoji character and for a particular culture, then it can be presumed that the emoji character is universal across at least the sender's culture and the recipient's culture.

That a replacement emoji character is more culturally relevant to the recipient than the emoji character the sender has entered can mean that both emoji characters have the same meaning within the respective cultures of the recipient and the sender, but have different pictorial depictions of this meaning. For example, as noted above, in different cultures different emoji characters can specify sickness, where in one culture such an emoji character may be a person wearing a surgical mask and in another culture such an emoji character may be a person having his or her temperature taken using a thermometer. Both of these emoji characters, then, have the same meaning in their respective cultures, but they have different pictorial depictions of this meaning. In this example, replacing the emoji character of a person wearing a surgical mask with the emoji character of a person using a thermometer reduces if not eliminates cross-cultural confusion, since to the culture of the recipient a person wearing a surgical mask may mean that the sender is a doctor as opposed to the sender being sick.

That a replacement emoji character is more culturally relevant to the recipient than the emoji character the sender has entered can mean other things as well. For example, different peoples across the globe have different physical characteristics. The sender may have entered an emoji character of a person that has physical characteristics similar to the sender. The replacement emoji character may thus be of a corresponding person, but one who has physical characteristics similar to the recipient. This is particularly the case when emoji characters include human faces. The human face in the replacement emoji character thus can have physical characteristics corresponding to the culture of the recipient, while the emoji character that the sender entered may have physical characteristics corresponding to the culture of the recipient.

Determining the replacement emoji character can occur as follows. The emoji character that the sender entered and the recipient's culture are looked up in an emoji character cultural database (110). The database maps the emoji character from the perspective of the culture of the sender to replacement emoji characters of one or more different cultures, including that of the recipient. As one example, the database may be organized as a number of records, where each record corresponds to an emoji character entered by the sender. Within each record, there can be one or more corresponding replacement emoji characters for each culture other than the sender's culture. Therefore, in this implementation, the sender's computing device looks up the record including the emoji character that the sender has entered. The computing device then looks up the field within this record that includes the culture of the recipient, to determine one or more replacement emoji characters for the sender-entered emoji character that are culturally relevant to the culture of the recipient.

In one implementation, there may be more than one replacement emoji characters that are culturally relevant to the recipient for the emoji character that the sender entered. In this case, it can be said that multiple potential replacement emoji characters are determined (112). Each potential replacement emoji character is potentially more culturally relevant to the recipient than the emoji character that the sender entered. Therefore, the computing device permits the sender to select which potential replacement emoji character to serve as the actual replacement emoji character for the emoji character entered by the sender (114).

In another implementation, there may just be one replacement emoji character that is culturally relevant to the recipient for the emoji character that the sender entered. In this case, the replacement emoji character can be automatically selected (116). That is, the sender is not involved in selecting the replacement emoji character. Indeed, the computing device may not even display or show the replacement emoji character to the sender. In some scenarios, the sender may not even be aware that the emoji character he or she has entered has been replaced by a replacement emoji character that is culturally relevant to the recipient.

The computing device thus replaces the emoji character entered by the sender with the replacement emoji character that has been determined as being more culturally relevant to the recipient (118). Note that the process that has been described from part 102 through part 118 of the method 100 can be performed in two different ways. First, the process can be performed as the sender enters each character of the message, such that the process is performed on a character-by-character basis as the characters are entered, prior to the sender signaling that the message is to be transmitted to the recipient, such as by selecting a “send” button. This approach presumes that the sender has already specified the recipient of the message, or at least the recipient's culture. Second, the process can be performed after the sender has finished inputting the message and has signaled that the message is to be transmitted to the recipient. This approach, then, scans the entire message for emoji characters after the message is finished.

The computing device completes the method 100 by transmitting the message to the recipient's computing device over a network (120). For example, email messages are typically transmitted over the Internet, while text messages may be transmitted over a mobile telephony network. Note that an advantage of the method 100 is that it permits a sender to send messages including culturally relevant emoji characters even if the recipient does not have this capability. That is, no changes have to be made at the computing device of the recipient for the method 100 to be implemented. The recipient can be completely unaware, indeed, that the sender's computing device is replacing emoji characters with those that are culturally relevant to the recipient. Thus, advantageously, this implementation of the techniques disclosed herein provides for culturally relevant emoji character replacement without involving both the sender and the recipient of a message, and rather involves just the sender.

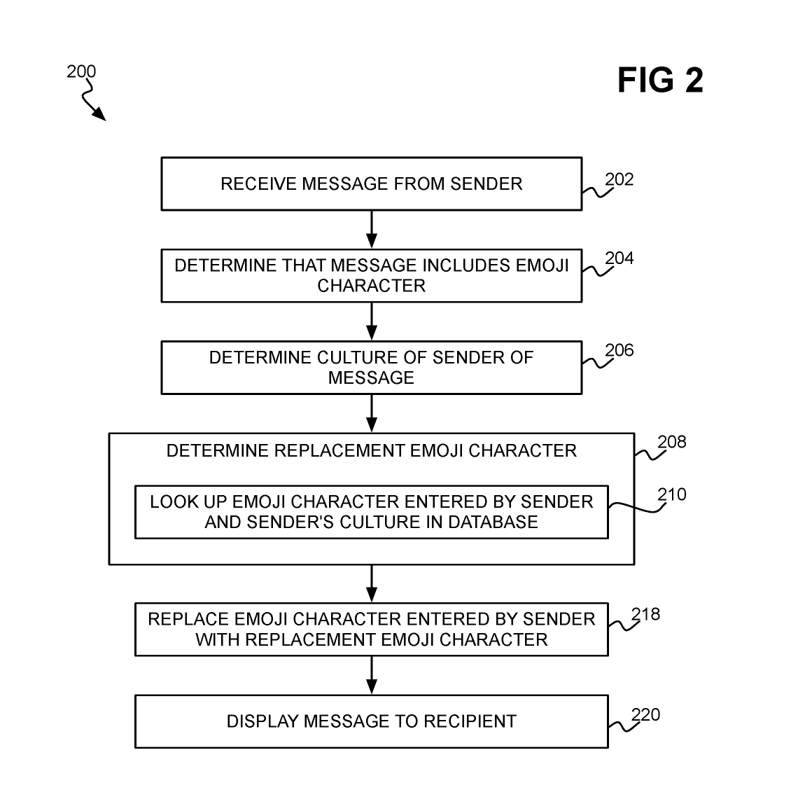

FIG. 2 shows another example method 200 for replacing an emoji character by a sender of an electronic message with a replacement emoji character culturally relevant to a recipient of the message. The method 200 is performed at the computing device of the recipient, which receives the message from the computing device that the sender used to compose and transmit the message, and which displays the message to the recipient. Thus, the computing device of the recipient first receives the message from the sender's computing device over a network (202).

The computing device determines that the message includes an emoji character (204), such as in the same manner that has been described as to part 104 of the method 100. As with the method 100, although the method 200 is described in relation to the message including one emoji character, the message can include more than one emoji character, with the process that is described below being performed for each such character. The description of the method 200 further presumes that the sender-entered emoji character will be replaced by a different, replacement emoji character that is culturally relevant to the recipient. However, as noted above, some emoji characters may be culturally universal, at least across the cultures of the sender and the recipient, in which case no such replacement occurs.

The computing device determines the culture of the sender of the message (206). This determination can be performed in the same manner that has been described as to part 106 of the method 100, but with respect to the sender and not with respect to the recipient. Note, then, that one difference between the methods 100 and 200 is that the method 200 determines the sender's culture, whereas the method 100 determines the recipient's culture.

The computing device of the recipient determines a replacement emoji character that is culturally relevant to the recipient (208). This can be achieved by looking up the emoji character entered by the sender and the sender's culture in an emoji character cultural database (210). The database maps the emoji character from the perspective of the culture of the sender to a replacement emoji character of the recipient's culture. As one example, the database may be organized as a number of records, where each record corresponds to an emoji character from the perspective of the culture of the sender. Within each record, there can be a corresponding replacement emoji character for the culture of the recipient.

The replacement emoji character can be automatically selected. That is, the recipient is not involved in selecting the replacement emoji character. The computing device may not even display or show the emoji character that the sender originally selected within the message that was received in part 202. In some scenarios, the recipient may not even be aware that the emoji character that the replacement emoji character that will be displayed to the recipient differs from the emoji character that the sender selected when composing and transmitting the message to the recipient. That is, the recipient may not be aware that culturally relevant emoji character replacement is occurring.

The computing device thus replaces the emoji character entered by the sender within the replacement emoji character that has been determined as being more culturally relevant to the recipient (218). The computing device then displays the message to the recipient (220), in which the emoji character entered by the sender has been replaced with the replacement emoji character. Note that the process from parts 204 through part 220 of the method 200 that has been described can be performed in two different ways. First, as the computing device is about to display a character within the message, it may check whether the character is an emoji character, select a replacement emoji character if there is one (i.e., if the emoji character is not culturally universal over both the sender's and the recipient's cultures), and display the emoji character before proceeding to the next character of the message, if any. Second, the computing device may first replace each emoji character within the message as appropriate, and then display the entire message.

An advantage of the method 200 is that it permits a recipient to receive messages and then displays them to the recipient with replacement emoji characters that are culturally relevant to the recipient even if the sender does not have this capability. No changes have to be made at the computing device of the sender for the method 200 to be implemented. The sender can indeed be completely unaware that the recipient's computing device is replacing emoji characters that the sender entered with those that are culturally relevant to the recipient. Thus, advantageously, this implementation of the techniques disclosed herein provides for culturally relevant emoji character replacement without involving both the sender and the recipient of a message, and rather involves just the recipient.

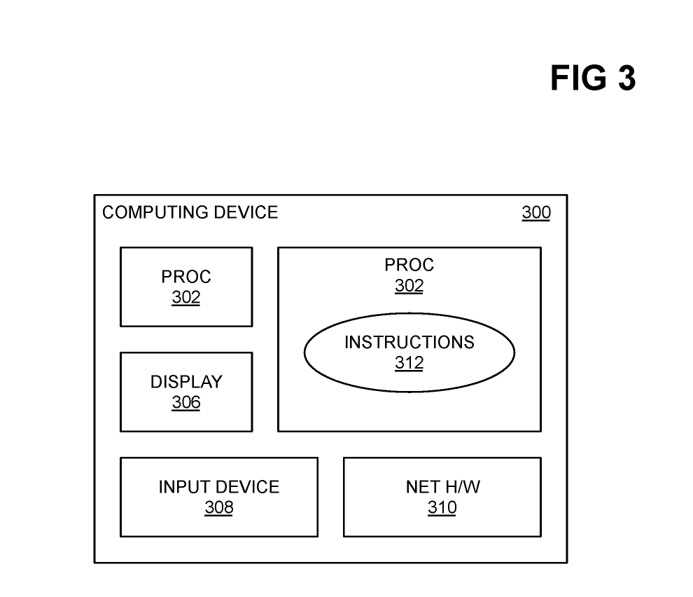

FIG. 3 shows an example computing device 300 that can implement the techniques that have been described. The computing device 300 may be a mobile computing device, such as smartphone or tablet computing device. The computing device 300 may be a computer, such a desktop computer, or a laptop or notebook computer. The computing device 300 can include a processor 302, a memory 304, a display 306, an input device 308, and network hardware 310.

The memory 304 can be a volatile or non-volatile memory device, and stores program instructions 312 that the processor 302 executes to perform the methods 100 and 200 that have been described. The display 306 can be a flat-screen display device. The input device 308 may be or include a physical keyboard, a touchscreen, a pointing device such as a mouse or touchpad, and so on. The network hardware 310 permits the computing device 300 to communicate with communication networks, such as mobile phone networks, the Internet, wireless and/or wired networks, and so on.

The techniques that have been disclosed herein thus relate to electronic messaging technology, such as email messaging technology and text messaging technology. The techniques disclosed herein provide an objective performance improvement in this technology. Specifically, via the techniques disclosed herein, culturally relevant emoji character replacement can occur more efficiently and more quickly than conventionally. That is, rather than a sender having to manually determine which emoji character is culturally relevant to a recipient when entering the emoji character in an electronic message, the sender can simply enter the emoji character with which he or she is familiar, from the perspective of the sender's own culture with which the sender is innately familiar. The techniques disclosed herein thus employ computing technology to achieve such emoji character replacement to improve electronic messaging technology.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

We claim:

1. A method comprising:
determining, by a computing device, that an electronic message entered by a sender user for a recipient user includes an emoji character;
determining, by the computing device, a replacement emoji character that is more culturally relevant to the recipient user than the emoji character entered by the sender user is; and
replacing, by the computing device, the emoji character entered by the sender user with the replacement emoji character that has been determined, within the electronic message.

2. The method of claim 1, wherein the computing device is of the sender user, the method further comprising:
transmitting the electronic message, by the computing device, to a computing device of the recipient user over a network.

3. The method of claim 2, further comprising:
determining, by the computing device, a culture of the recipient user,
wherein determining the replacement emoji character comprises:
looking up the emoji character entered by the sender user and the culture of the recipient user within a emoji character cultural database to determine the replacement emoji character,
wherein the emoji character cultural database maps the emoji character of a culture of the sender user to the replacement emoji character of the culture of the recipient user.

4. The method of claim 3, wherein determining the culture of the recipient user is based on one or more of:
an identification of the recipient user by which the electronic message is transmitted to the computing device of the recipient user over the network;
a geographic location of the recipient user;
a cultural indication of the recipient user as received from the recipient user;
a cultural indication of the recipient user as specified by the sender user.

5. The method of claim 2, wherein determining the replacement emoji character comprises:
determining a plurality of potential replacement emoji characters that are potentially more culturally relevant to the recipient user than the emoji character entered by the sender user is; and
permitting the sender user to select the replacement emoji character from the potential replacement emoji characters.

6. The method of claim 2, wherein determining the replacement emoji character comprises:
selecting the replacement emoji character automatically and without involvement of the sender user.

7. The method of claim 2, wherein determining that the electronic message includes the emoji character, determining the replacement emoji character, and replacing the emoji character with the replacement emoji character are performed as the sender user inputs the electronic message on a character-by-character basis, prior to the sender user signaling that the electronic message is to be transmitted to the recipient user.

8. The method of claim 2, wherein determining that the electronic message includes the emoji character, determining the replacement emoji character, and replacing the emoji character with the replacement emoji character are performed after the sender user has input the electronic message and has signaled that the electronic message is to be transmitted to the recipient user.

9. The method of claim 1, wherein the computing device is of the recipient user, the method further comprising:
receiving the electronic message, by the computing device, from a computing device of the sender user over a network; and
displaying the electronic message, by the computing device, to the recipient user.

10. The method of claim 9, further comprising:
determining, by the computing device, a culture of the sender user,
wherein determining the replacement emoji character comprises:
looking up the emoji character entered by the sender user and the culture of the sender user within a emoji character cultural database to determine the replacement emoji character,
wherein the emoji character cultural database maps the emoji character of the culture of the sender user to the replacement emoji character of a culture of the recipient user.

11. The method of claim 10, wherein determining the culture of the sender user is based on one or more of:
an identification of the sender user by which the electronic message was transmitted from the computing device of the sender user over the network;
a geographic location of the sender user;
a cultural indication of the sender user as received from the sender user;
a cultural indication of the sender user as specified by the recipient user.

12. The method of claim 9, wherein determining the replacement emoji character comprises:
selecting the replacement emoji character automatically and without involvement of the recipient user.

13. The method of claim 9, wherein determining that the electronic message includes the emoji character, determining the replacement emoji character, and replacing the emoji character with the replacement emoji character are performed after the computing device of the recipient user has received the electronic message from the computing device of the sender user over the network and before the computing device of the recipient user displays the electronic message to the recipient user.

14. The method of claim 1, wherein the replacement emoji character has a same meaning within a culture of the recipient user as the emoji character has within a culture of the sender user,
and wherein the replacement emoji character differs from the emoji character in how the same meaning is pictorially depicted within the culture of the recipient user as compared to within the culture of the sender user.

15. The method of claim 1, wherein the replacement emoji character and the emoji character both include a human face, but the human face in the replacement emoji character has physical characteristics corresponding to the culture of the recipient user and the emoji character has physical characteristics corresponding to the culture of the sender user.

16. The method of claim 1, wherein replacing the emoji character entered by the sender user with the replacement emoji character that has been determined reduces cross-cultural confusion between the sender user and the recipient user.

17. A computer program product comprising a computer readable storage medium having stored thereon program instructions executable by a computing device to cause the computing device to:
determine that an electronic message entered by a sender user for a recipient user includes an emoji character;
determine a replacement emoji character that is more culturally relevant to the recipient user than the emoji character entered by the sender user is; and
replace the emoji character entered by the sender user with the replacement emoji character that has been determined, within the electronic message.

18. The computer program product of claim 17, wherein the program instructions are executable by the computing device to cause the computing device to further:
determine a culture of the recipient user, the computing device to determine the replacement emoji character by looking up the emoji character entered by the sender user and the culture of the recipient user within a emoji character cultural database to determine the replacement emoji character, the emoji character cultural database mapping the emoji character of a culture of the sender user to the replacement emoji character of the culture of the recipient user; and
transmit the electronic message to a computing device of the recipient user over a network.

19. The computer program product of claim 17, wherein the program instructions are executable by the computing device to cause the computing device to further:
receive the electronic message from a computing device of the sender user over a network;
determine a culture of the sender user, the computing device to determine the replacement emoji character by looking up the emoji character entered by the sender user and the culture of the sender user within a emoji character cultural database to determine the replacement emoji character, the emoji character cultural database mapping the emoji character of the culture of the sender user to the replacement emoji character of a culture of the recipient user; and
display the electronic message to the recipient user.

20. A computing device comprising:
a processor;
a memory; and
program instructions stored in the memory and executable by the processor to:
determine that an electronic message entered by a sender user for a recipient user includes an emoji character;
determine a replacement emoji character that is more culturally relevant to the recipient user than the emoji character entered by the sender user is; and
replace the emoji character entered by the sender user with the replacement emoji character that has been determined, within the electronic message.
